(19) United States
(12) Patent Application Publication
(10) Pub. No.: US 2003/0115472 A1
(43) Pub. Date: Jun. 19, 2003

(54) Data protection method and device by using address

(76) Inventor: l-Lang Chang, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/064,186

(22) Filed: Jun. 20, 2002

(30) Foreign Application Priority Data
Dec. 19, 2001 (TW) 90131444

(51) Int. Cl. H04L 9/00

(52) U.S. Cl. 713/182; 713/202

(57) ABSTRACT

A data protection method and device by using address. A memory device is used to establish a database that comprises a usage authorization when the address of the data is used to distinguish the usage authorization when a user accesses the data as well as the password that is needed for the authentication to release the usage authorization. An address decoder is used to determine whether the access of the data exceeds the data usage authorization when user accesses the data. If it does, notifying the user to input an authentication password. If it does not, the data can be directly accessed and used by the user. Further comparing the authentication password input by the user with the password that is stored in the database inside the memory device. If they match each other, the data usage authorization is released and the user can access and use the data. If they do not match, then the user is restricted to use the data within the usage authorization.

### CROSS REFERENCE TO RELATED APPLICATIONS

This application claims the priority benefit of Taiwan application serial no. 90131444, filed Dec. 19, 2001.

### BACKGROUND OF INVENTION

1. Field of Invention

The present invention generally relates to a data protection method and device, and more particularly, to a data protection method and device by using address.

2. Description of Related Art

As to setup of the Basic Input/Output System (abbreviated as BIOS hereinafter) or access of important data on the hard disk, human error may result in BIOS setup error or loss of important data or wrongful data access of important data. Moreover, since the Internet is widely used now, quite often a virus attacks the computer because of the user's negligence. The computer virus may overwrite the setup of the BIOS or perform wrongful hard disk data access, resulting in malfunction of the personal computer.

Conventionally, there are two methods for accessing the BIOS or hard disk data in a personal computer: the first method does not adopt any protection mechanism, the second one uses a special setting to control the access. However since the setup method is well known by many vendors, the setup method is often treated as public information and thus is easily broken through.

### SUMMARY OF INVENTION

Therefore, the present invention provides a data protection method and device by using address to control the usage authorization of accessing the BIOS or the hard disk through software or hardware and to release the data usage authorization by using a variant method according to the importance of the accessed data.

The present invention provides a BIOS data protection device by using address to protect the BIOS that is controlled by the chipset. The device comprises a memory device and an address decoder. Wherein, the memory device builds a database inside the memory device according to the address of the data in the BIOS. The database records the usage authorization when the data is used and the password for releasing the usage authorization. The address decoder couples to the chipset, the BIOS and the memory device. The address decoder receives the control signal that is sent from the chipset, decodes it and obtains usage information for comparing the address and the data usage authorization, and also receives the authentication password. Therefore, the address decoder restricts the control that is applied from the chipset onto the data according to the data usage authorization, receives the authentication password that is sent to the address decoder through the chipset, and compares the password, so that usage authorization can be released.

The present invention further provides a hard disk data protection device by using address to protect the hard disk that is controlled by the chipset. The device comprises a memory device and an address decoder. Wherein, the memory device builds a database inside the memory device according to the address of the data in the hard disk. The database records the usage authorization when the data is used and the password for releasing the usage authorization. The address decoder couples to the chipset, the hard disk and the memory device. The address decoder receives the control signal that is sent from the chipset, decodes it and obtains usage information for comparing the address and the usage authorization of the data, and also receives the authentication password. Therefore, the address decoder restricts the control that is applied from the chipset onto the data according to the data usage authorization, receives the authentication password that is sent to the address decoder through the chipset, and compares the password, so that the usage authorization can be released.

As mentioned above, in the preferred embodiment of the present invention, the memory device builds a database inside the memory device according to an address range that is included in a plurality of data records in the hard disk. The database records the usage authorization of the plurality of data records when they are accessed and the password for releasing the usage authorization. The authentication password can be obtained by using a keyboard, a mouse, an encryption/decryption engine, a smart card, a key, or a biotic characteristic.

In summary, the present invention distinguishes and establishes a usage authorization when the data is accessed and a password for releasing the usage authorization by using the address of the accessed data. When a user accesses data and exceeds the data usage authorization, the user has to input an authentication password that is equal to the password mentioned above to release the data usage authorization. Otherwise, the user can not access the data. The present invention is able to avoid the mistaken usage of important data (such as the important data stored in the BIOS or the hard disk) by a user or virus, that may result in the malfunction or even the invalidation of the whole computer system.

### BRIEF DESCRIPTION OF DRAWINGS

The accompanying drawings are included to provide a further understanding of the invention, and are incorporated in and constitute a part of this specification. The drawings illustrate embodiments of the invention, and together with the description, serve to explain the principles of the invention. In the drawings,

FIG. 1 schematically shows a flow chart of the data protection method by using address of a preferred embodiment according to the present invention;

FIG. 2A schematically shows a circuit block diagram of the data protection device by using address of another preferred embodiment according to the present invention;

FIG. 2B schematically shows a circuit block diagram of the data protection device by using address of another preferred embodiment according to the present invention.

### DETAILED DESCRIPTION

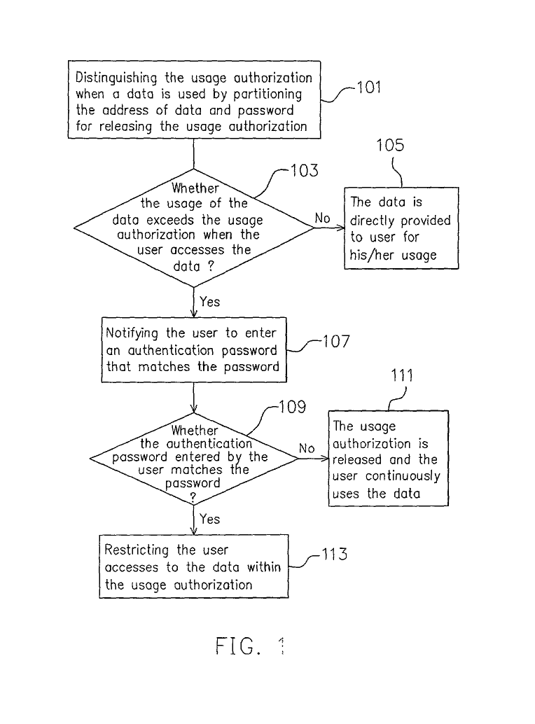

The concept of the present invention partitions the address of the accessed data, so that data having different addresses have equal or non-equal usage authorization when they are used to avoid mistaken usage or breakage of the data by a user or virus. FIG. 1 schematically shows a flow chart of the data protection method by using address of a preferred embodiment according to the present invention. In step 101, at first, partitioning the address according to the address of the accessed data, partitioning the address of each record of data or the address range that is included in each multiple record of data, respectively creating the data that has this address or the data that is in this address range and the usage authorization when they are used as well as the password for releasing the usage authorization according to the partitioned address or the address range. The password can be created by the user or provided by a vendor as long as it is secret information. In step 103, determining whether the user exceeds the data usage authorization when the user accesses the data. If yes, in step 105, the user can access the data directly. If no, in step 107, notifying the user to input an authentication password that equals the password mentioned above for authentication, so that the data usage authorization can be released and the user can access and use the data. When the user inputs an authentication password, in step 109, comparing the authentication password with the password mentioned above and determining whether the authentication succeeds or not. If the authentication succeeds, in step 111, releasing the data usage authorization, so that the data can be used without any restriction. If the authentication does not succeed, in step 113, restricting the user accessing the data within the usage authorization, so that the objective of protecting the data can be achieved.

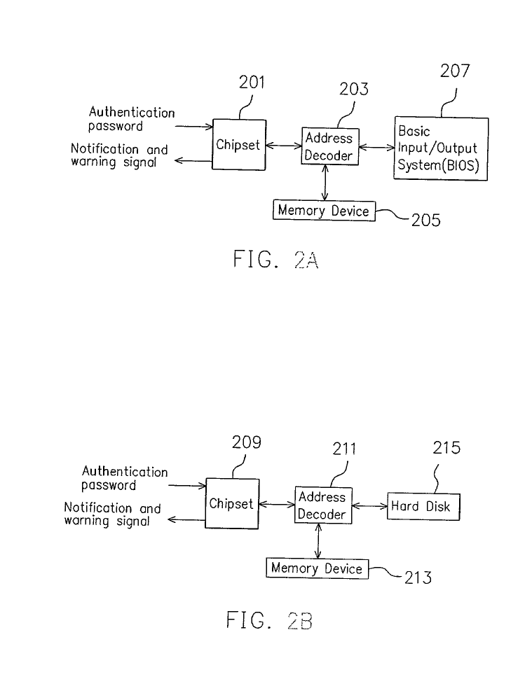

Please refer to FIG. 2A and FIG. 2B for the data protection device by using address according to the present invention. FIG. 2A and FIG. 2B are the preferred embodiment that provides the data protection to the BIOS and hard disk in the applied personal computer. When a user accesses data from BIOS 207, a signal, sent from the chipset 201, that includes a command and a memory address, is used to perform an access operation onto the data that has a specific address in the BIOS 207. In order to restrict the user (or a virus) from accessing the internal data of the BIOS 207, a data protection device that uses address and consists of a decoder 203 and a memory device 205 is coupled between the chipset 201 and the BIOS 207. The memory device 205 builds a database inside the memory device 205, the database comprises a field of a plurality of address ranges (the plurality of address ranges partition the address of all data in the BIOS 207 into multiple ranges), a field of a usage authorization, and a field of a self-defined password as shown in the following Table 1.

TABLE I

| | | | Self-defined |
|---|---|---|---|
| Start Address | End Address | Usage Authorization | Password |
| AAAH | BBBH | Read, No Write | Abcdefg |
| BBBH | DDDH | Read, No Write | Ddeefor |
| DDDH | FFFH | No Read, No Write | Jfldjfdi |

When the user accesses a record of data stored in BIOS 207, and the address of the data is within the DDDH˜FFFH address range, the chipset 201 sends a signal that consists of a command and a memory address to the address decoder 203. The address decoder 203 decodes this signal and obtains usage information (this usage information comprises a read or write operation for the data that has a specific address inside BIOS 207). The address decoder 203 then compares the usage information with the usage authorization (whether it has the right to read or write) of the data whose address is within the specific address range (DDDH˜FFFH) in the database inside the memory device 205. If the operation mode (read or write) disclosed by the usage information does not exceed the data usage authorization, the address decoder 203 directly outputs a signal that consists of a command and a memory address to BIOS 207, so that the user can directly access and use the data in BIOS 207 through the chipset 201. If the operation mode disclosed by the usage information exceeds the data usage authorization, the address decoder 203 outputs a notification signal via the chipset 201 to notify the user to enter a password (jfldjfdi) that matches the password that corresponds to the data in the database of the memory device 205 to authenticate and then release the data usage authorization. When the authentication password entered by the user is input to the address decoder 203 through the chipset 201, the address decoder 203 compares the input authentication password with the password that corresponds to the data in the database of the memory device 205 for authentication. If the authentication succeeds, the address decoder 203 outputs the signal that consists of the command and the memory address to BIOS 207, so that this information can be used to control the access. When the authentication password entered by the user does not match the corresponding password (a virus can not break through the corresponding password), the address decoder 203 cuts off the signal that consists of the command and the memory address, so that the access control of the data in BIOS 207 through the chipset 201 by the user can be cancelled, thus the objective of protecting the data in BIOS 207 can be achieved. Moreover, the address decoder 203 issues a warning signal to notify the user that the system is abnormally used or the data in BIOS 207 is attacked by a virus.

Of course, it is known for those who skilled in the related arts that the address decoder and the memory device can be integrated into the chipset. Optionally, the address decoder, the memory device and the BIOS can be integrated into a single integrated circuit (IC) chip, so that the objective of the present invention can be achieved.

In FIG. 2B, the operating method of the data protection device that uses address and consists of an address decoder 211 and a memory device 213 between the chipset 209 and the hard disk 215 is the same as the one described in FIG. 2A. Moreover, the address decoder and the memory device can also be integrated into an integrated circuit (IC) of a redundant array of intelligent disks (RAID), or integrated into the chipset, or integrated into the hard disk, so that the objective of the present invention can be achieved.

Furthermore, it is known for those who skilled in the related art that the user can use different methods to obtain the password that matches the authentication password for releasing the data usage authorization based on the importance level of the data, and also can also use different methods to authenticate. For example, the user can obtain and enter the authentication password by using a keyboard, a mouse, a smart card having chip on it, by connecting to the Internet and utilizing the encryption/decryption engine for authentication. The authentication password also can be obtained by using a biotic characteristic, such as the transformation result of the fingerprint or the sound waveform via the analog/digital transformation process.

In summary, the present invention partitions an address of the accessed data, establishes the data usage authorization when it is used as well as the password for releasing its usage authorization. When the user uses the data and exceeds its data usage authorization, the user has to input an authentication password that equals the password mentioned above to release the data usage authorization. Otherwise, the user can not access and use the data. The method to obtain the authentication password can be different according to the importance level of the data. The present invention can avoid the misuse of important data (such as important data inside the BIOS or hard disk) by a user or virus, that could result in the malfunction or even the invalidation of the whole computer system.

Although the invention has been described with reference to a particular embodiment thereof, it will be apparent to one of the ordinary skill in the art that modifications to the described embodiment may be made without departing from the spirit of the invention. Accordingly, the scope of the invention will be defined by the attached claims not by the above detailed description.

1. A data protection device by using address, performing a data protection operation by controlling an access of a data in a Basic Input/Output System (BIOS), the device comprising:
a memory device, wherein the memory device builds a database according to the address of the data in the BIOS, and the database records a usage authorization of the data and a password for releasing the usage authorization; and
an address decoder, wherein the address decoder couples to a chipset, the BIOS, and the memory device, the address decoder receives and decodes a control signal to obtain an usage information, compares with the address and the usage authorization, and receives an authentication password;
wherein the address decoder restricts the control that the chipset applies to the data according to the usage authorization, and receives the authentication password that is sent to the address decoder, compares the password, and releases the usage authorization.

2. The data protection device by using address of claim 1, wherein the memory device and the address decoder can be integrated into the chipset.

3. The data protection device by using address of claim 1, wherein the memory device, the address decoder and the BIOS can be integrated into a chipset.

4. The data protection device by using address of claim 1, wherein the memory device can build a database according to an address range that includes a plurality of data records in the BIOS, and the database records a usage authorization of the plurality of data records and a password to release the usage authorization of the plurality of data records.

5. The data protection device by using address of claim 1, wherein the authentication password can be provided by a keyboard, a mouse, an encryption/decryption engine, a smart card, a key or a biotic characteristic.

6. The data protection device by using address of claim 1, wherein the address decoder further sends out a warning signal when the chipset exceeds the data usage authorization or when the authentication password is not accepted.

7. The data protection device by using address of claim 5, wherein the biotic characteristic comprises either a fingerprint or a sound waveform.

8. The data protection device by using address of claim 5, wherein the authentication password can be provided by a combination of the keyboard, the mouse, the encryption/decryption engine, the smart card, the key and the biotic characteristic.

9. A data protection device by using address, performing a data protection operation by controlling an access of a data in a hard disk, the device comprising:
a memory device, wherein the memory device builds a database according to the address of the data in the hard disk, and the database records a usage authorization of the data and a password for releasing the usage authorization; and
an address decoder, wherein the address decoder couples to a chipset, the hard disk, and the memory device, the address decoder receives and decodes a control signal to obtain a usage information, compares with the address and the usage authorization, and receives an authentication password;
wherein the address decoder restricts the control that the chipset applies to the data according to the usage authorization, and receives the authentication password that is sent to the address decoder, compares the password, and releases the usage authorization.

10. The hard disk data protection device by using address of claim 9, wherein the memory device and the address decoder can be built-in inside the chipset.

11. The hard disk data protection device by using address of claim 9, wherein the memory device and the address decoder can be built-in inside the hard disk.

12. The hard disk data protection device by using address of claim 9, wherein the memory device and the address decoder can be built-in inside an integrated circuit (IC) that controls a redundant array of intelligent disks (RAID).

13. The hard disk data protection device by using address of claim 9, wherein the memory device can build a database according to an address range that includes a plurality of data records in the hard disk, and the database records a usage authorization of the plurality of data records and a password to release the usage authorization of the plurality of data records.

14. The hard disk data protection device by using address of claim 9, wherein the authentication password can be provided by a keyboard, a mouse, an encryption/decryption engine, a smart card, a key or a biotic characteristic.

15. The hard disk data protection device by using address of claim 9, wherein the address decoder further sends out a warning signal when the chipset exceeds the data usage authorization or when the authentication password is not accepted.

16. The hard disk data protection device by using address of claim 14, wherein the biotic characteristic comprises either a fingerprint or a sound waveform.

17. The hard disk data protection device by using address of claim 14, wherein the authentication password can be provided by a combination of the keyboard, the mouse, the encryption/decryption engine, the smart card, the key and the biotic characteristic.
